(19) United States
(12) Patent Application Publication
(10) Pub. No.: US 2010/0153790 A1
(43) Pub. Date: Jun. 17, 2010

(54) PERFORMANCE TROUBLE ISOLATION SUPPORT APPARATUS

(75) Inventors: Yasuhide Matsumoto, Kawasaki (JP); Yukihiro Watanabe, Kawasaki (JP); Kuniaki Shimada, Kawasaki (JP); Koichi Sakai, Tokyo (JP); Kazuhiko Hagino, Kawasaki (JP); Akira Katsuno, Kawasaki (JP)

Correspondence Address: GREER, BURNS & CRAIN, 300 S WACKER DR, 25TH FLOOR, CHICAGO, IL, 60606, US

(73) Assignees: FUJITSU LIMITED, Kawasaki-shi (JP); FUJITSU FSAS INC., Tokyo (JP)

(21) Appl. No.: 12/563,792

(22) Filed: Sep. 21, 2009

(30) Foreign Application Priority Data
Dec. 17, 2008 (JP) 2008-320991

(51) Int. Cl. G06F 11/07

(52) U.S. Cl. 714/47; 714/E11.024

(57) ABSTRACT

Operation information about a component of an information system is acquired by a CMDB (configuration management database). An investigation information DB stores assumption narrowing information including a plurality of inquiry items to be issued to a user to narrow a cause of a fault of an information system to a specific assumption, and assumption verification information including information necessary for verification of an assumption for each of a plurality of assumptions included in the assumption narrowing information. An inquiry item optimizing function unit refers to the assumption verification information stored in the investigation information DB and operation information stored in the CMDB, generates priority assignment information necessary in assigning a priority to the inquiry item, and assigns the priority to the inquiry item included in the assumption narrowing information on the basis of the priority assignment information.

### CROSS-REFERENCE TO RELATED APPLICATIONS

This application is based upon and claims the benefit of priority of the prior Japanese Patent Application No. 2008-320991, filed on Dec. 17, 2008, the entire contents of which are incorporated herein by reference.

### FIELD

The embodiments described below relate to the operation management of an information system.

### BACKGROUND

IT systems, that is, information systems, have been increasing year by year both in number and complexity. With the increasing of the IT systems, the causes of performance trouble (faults) have been diversified. Therefore, every year it has been more and more difficult to designate the causes of the performance trouble.

Normally, a fault diagnostic expert system has been used in a search for a cause of a fault of an IT system. As a common fault diagnostic expert system, a fault diagnostic expert system for a robot controller is well known (Japanese Laid-open Patent Publication No. 06-222922). The fault diagnostic expert system is configured to generate a knowledge base on the basis of a certain knowledge expression model, and control the progress of assumption based on the knowledge base.

In an interaction system, a device for designating a user information request with high accuracy is also well known (Japanese Laid-open Patent Publication No. 2004-354787). The device assigns a score to one or more candidates for a user information request by using a statistical standard obtained from previous interaction data. The device can acquire contents for a user information request with high accuracy by assigning a higher priority to a candidate having a higher score for a user information request.

The above-mentioned conventional fault diagnostic expert system employs a method in which a system administrator is issued sequentially the questions necessary to designate a cause of performance trouble and narrow the causes of the performance trouble. However, since the order of questions are not optimized, it often takes a long time to isolate the cause of performance trouble.

### SUMMARY

According to an aspect of the invention, a recording medium which stores a performance trouble isolation support program used to direct a computer to function as a performance trouble isolation support apparatus for isolating a cause of performance trouble by issuing an inquiry in an interactive mode to a user when the performance trouble occurs in an information system, the performance trouble isolation support program includes the processes of: acquiring operation information about a component of the information system; and optimizing an inquiry item by referring to assumption narrowing information stored in a storage unit and including a plurality of inquiry items for an inquiry to a user to narrow causes of a fault of the information system to a specific assumption, assumption verification information including information necessary to verify assumptions for each of a plurality of assumptions included in the assumption narrowing information, and the operation information, generating priority assignment information necessary to assign priorities to the inquiry items, and assigning priorities to the inquiry items included in the assumption narrowing information according to the priority assignment information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of the configuration of the system of a performance trouble isolation support apparatus according to an embodiment;

FIG. 2 is a block diagram of the configuration of the system of a performance trouble isolation support apparatus according to an embodiment;

FIG. 3 is an example of a data structure of an investigation information DB;

FIG. 4 is an example of an assumption narrowing sheet;

FIG. 5 is an example of an assumption verification sheet;

FIG. 6 is an example of storing operation information about a CI stored in the CMDB in FIG. 1;

FIG. 7 is an explanatory view of the relationship between assumption verification information and priority assignment information, and the outline of the operation of an unoperated CI extraction unit;

FIG. 8 is a flowchart of the procedure performed by the unoperated CI extraction unit for extracting the number of related CIs;

FIG. 9 is an explanatory view of the outline of the operation of an operation information difference extraction unit;

FIG. 10 is a flowchart of the procedure performed by an operation information difference extraction function unit;

FIG. 11 is a flowchart of the procedure performed by the extraction unit in FIG. 8 and the extraction unit (first extraction unit) in FIG. 10;

FIG. 12 illustrates a method of using priority assignment information associated with the assumption narrowing sheet illustrated in FIG. 5;

FIG. 13 is an explanatory view of the method of using the priority assignment information associated with each assumption verification sheet;

FIG. 14 is a schematic diagram of the method of displaying a “question” and “answer” using a sum of priority assignment information;

FIG. 15 is a flowchart of the procedure performed by an isolation support information display function unit; and

FIG. 16 is a block diagram of the hardware configuration of a computer achieving the function of the isolation support information display function unit and the item optimization unit of the performance trouble isolation support apparatus by executing the performance trouble isolation support program.

### DESCRIPTION OF EMBODIMENTS

The following descriptions refers to an information system as an IT system.

### [System Configuration]

### Configuration According to the First Embodiment

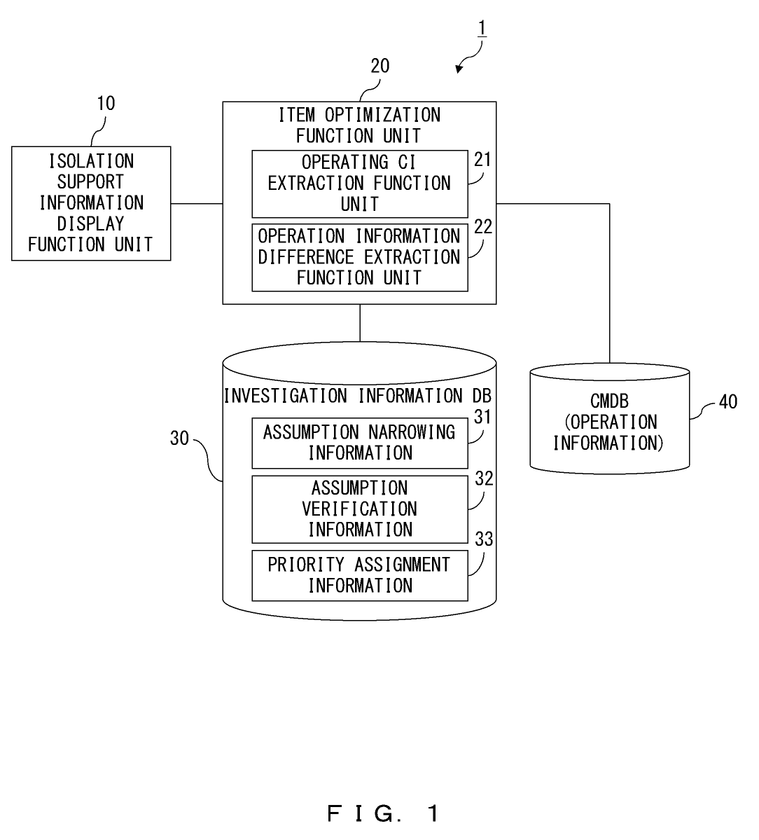

FIG. 1 is a block diagram of the system configuration of a performance trouble isolation support apparatus according to the first embodiment.

A performance trouble isolation support apparatus 1 illustrated in FIG. 1 includes an isolation support information display function unit 10, an item optimization function unit 20, an investigation information database (investigation information DB) 30, and a CMDB (configuration management database) 40.

The isolation support information display function unit 10 has a function of displaying on a display unit a screen on which an inquiry necessary for the isolation is issued to a user.

An item optimization function unit (inquiry item optimizing function unit) 20 includes an operating CI extraction function unit 21 and an operation information difference extraction function unit 22.

The operating CI extraction function unit 21 extracts a CI (configuration item) from the CMDB 40. The CI is described later in detail. The operation information difference extraction function unit 22 refers to the CMDB 40 and extracts the difference between the CI operation information before a fault and the information after the fault. The details of the functions of the operating CI extraction function unit 21 and the operation information difference extraction function unit 22 are described later.

The investigation information DB 30 is a database provided for achieving stepwise assumption narrowing. The investigation information DB 30 stores assumption narrowing information 31, assumption verification information 32, and priority assignment information (P.A.I) 33. The assumption narrowing information 31 relates to the content of questions to be issued to a user to narrow a cause of a fault to a specific assumption. The assumption verification information 32 relates to a practical procedure of verifying a specific assumption.

The priority assignment information 33 corresponds to an assumption narrowing sheet 311 included in the assumption verification information 32 described later, and is used in assigning a priority to each assumption verification sheet 321. The configuration of the priority assignment information 33 is described later in detail.

The CMDB 40 is a configuration management database (CMDB) in accordance with the standard of the ITIL (IT infrastructure library). The CMDB is defined as a “database for central management of all CIs (configuration items) relating to an IT service” in the ITIL. The CI corresponds to all items relating to the IT system such as hardware and software as the components of an IT system, listings generated in each processes for an incident, a change request, etc, documents and contract forms such as system design drawings, manuals, etc. The CMDB 40 according to the present embodiment stores the operation information about a CI. The operation information about the CI relates to a CI currently operating in an IT system. The operation information about the CI may be, for example, “whether or not the CI is being activated”, “what the use rate of the CI is”, etc. In the subsequent explanation, the operation information about a CI may be expressed simply by “operation information”.

### Configuration According to the Second Embodiment

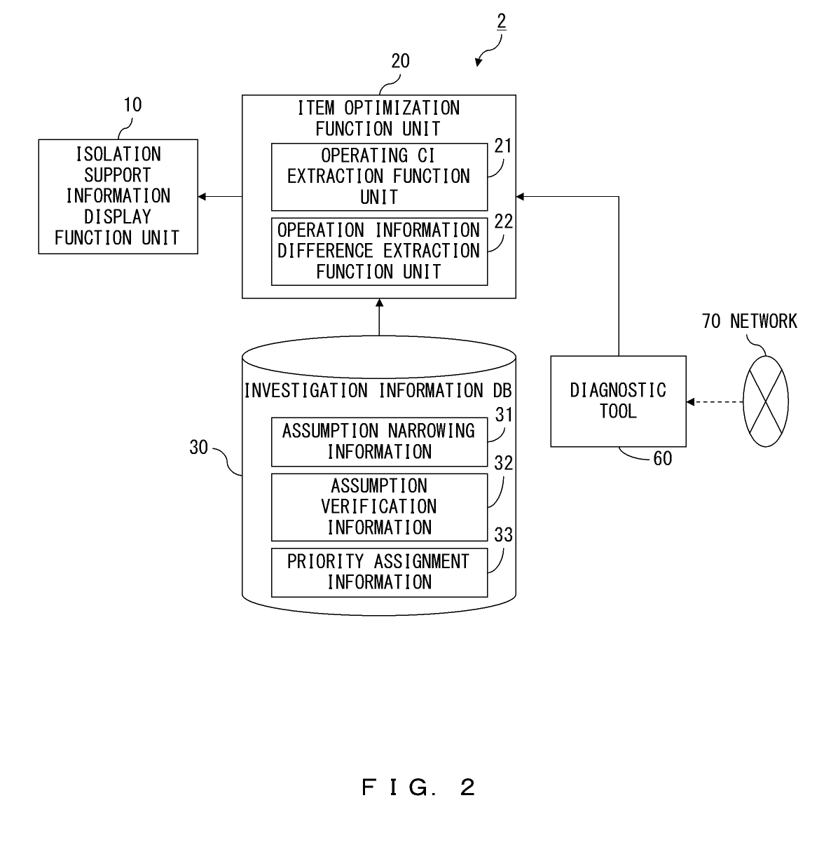

FIG. 2 is a block diagram of the system configuration of a performance trouble isolation support apparatus according to the second embodiment. In FIG. 2, the components also illustrated in FIG. 1 are assigned the same reference numerals.

The difference in configuration between a performance trouble isolation support apparatus 2 illustrated in FIG. 2 and the performance trouble isolation support apparatus 1 illustrated in FIG. 1 is that the performance trouble isolation support apparatus 2 is provided with a diagnostic tool 60 instead of the CMDB 40 as a unit for acquiring operation information.

The diagnostic tool 60 may be a network diagnostic tool etc. The diagnostic tool 60 grasps the situation of the operation of an IT system by acquiring the operation information about the CI operating in the IT system from a network 70. The diagnostic tool 60 collects, for example, the information about the traffic and errors in the network 70, and analyzes the quality, safety, etc. of the network 70. The diagnostic tool 60 also collects, for example, the information of whether a network connection of a node is working or not in the IT system, or of the situation of the network 70, etc. using a PING (packet Internet groper) etc.

Described next are the components commonly provided for the performance trouble isolation support apparatuses 1 and 2 according to the first and second embodiments.

### [Configuration of the Investigation Information DB 30]

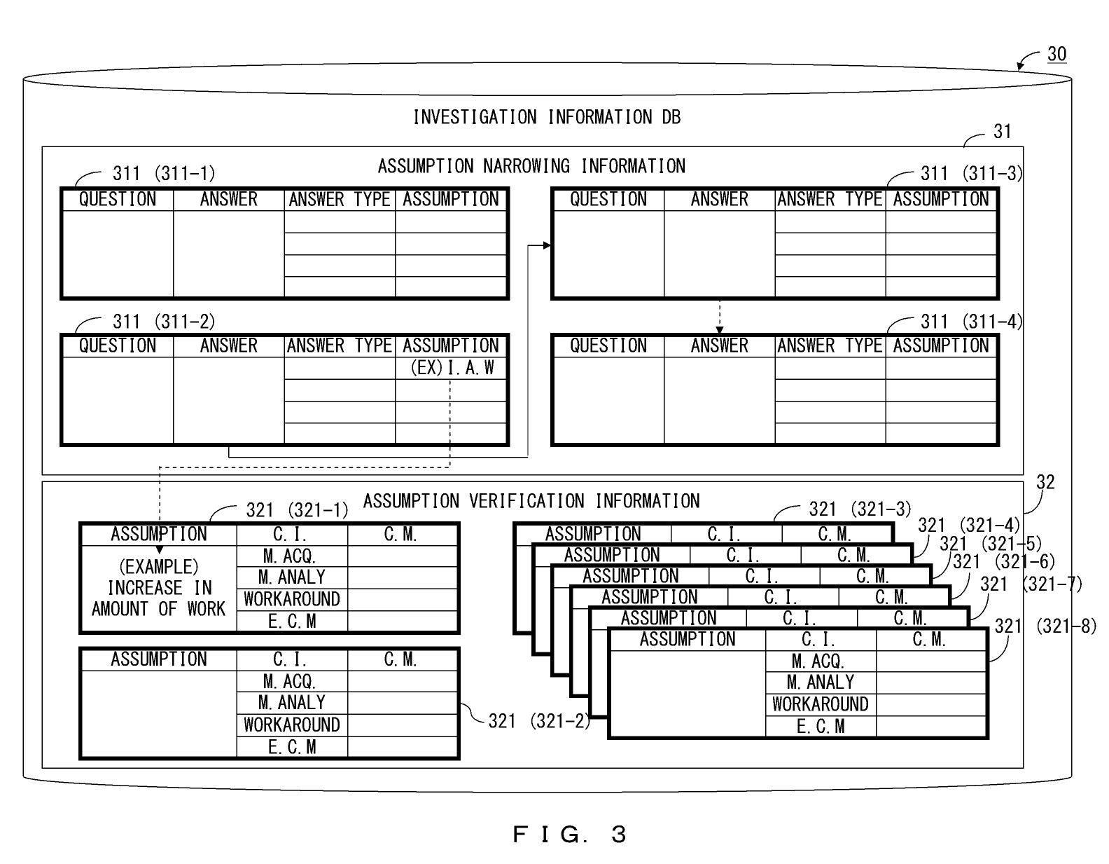

FIG. 3 is an example of a data structure of the investigation information DB 30 according to the first and second embodiments. In the investigation information DB 30 illustrated in FIG. 3, the priority assignment information 33 is omitted.

The investigation information DB 30 includes the assumption narrowing information 31 and the assumption verification information 32 as described above. The assumption narrowing information 31 is used in narrowing to a specific assumption. The assumption narrowing information 31 is configured by a plurality of assumption narrowing sheets 311 (311-1, 311-2, 311-3, and 311-4). In the example illustrated in FIG. 3, the assumption narrowing information 31 is provided with four assumption narrowing sheets 311, but the number of assumption narrowing sheet 311 provided for the assumption narrowing information 31 is not limited to this number.

The assumption narrowing sheet 311 is a sheet on which contents of questions etc. for narrowing to a specific assumption are described (set). The assumption narrowing sheet 311 includes four items of “question”, “answer”, “answer type”, and “assumption”. The present embodiment generates a plurality of assumption narrowing sheets 311, and stores them in the investigation information DB 30, thereby achieving stepwise assumption narrowing.

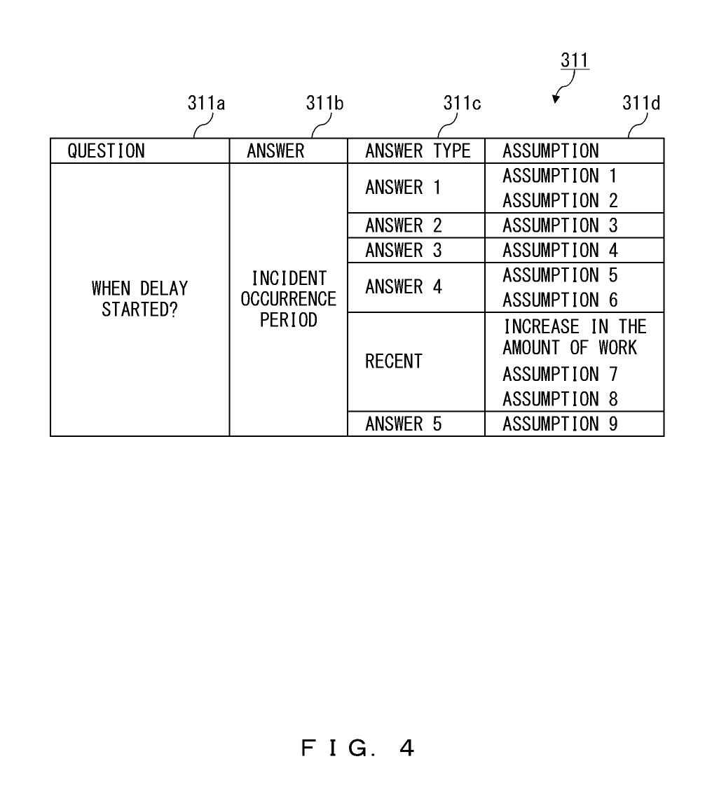

FIG. 4 is an example of an assumption narrowing sheet 311.

A question 311a includes contents of a question for narrowing an assumption. In this example, the question 311a is When did the delay start?”. An answer 311b is an answer item name for the question 311a. In this example, it is an “incident occurrence period”. An answer type 311c is the type of the answer 311b in response to the question 311a. In this example, there are six types for the answer type 311c, that is, “answer 1”, “answer 2”, “answer 3”, “answer 4”, “recent”, and “answer 5”. In FIG. 4, answers 1 through 4 and 5 are expressed in the abstract, but these answers are actually practical expressions of “incident occurrence period”. An assumption 311d corresponds to the answer type 311c. In the assumption 311d, one or more assumptions are described (set). In the assumption narrowing sheet 311 illustrated in FIG. 4, three assumptions, that is, “increase in the amount of work (I.A.W)”, “assumption 7”, and “assumption 8”, are described (set) for the answer type 311c of “recent”. For other answer types 311c, one or more assumptions are described (set).

In the present embodiment, as illustrated in FIG. 3, a plurality of assumption narrowing sheets 311-1 through 311-4 are linked sequentially from the leading sheet. The link is achieved by, for example, a pointer etc. The item optimization function unit 20 reads each assumption narrowing sheet 311 from the investigation information DB 30 by trailing the link.

The assumption verification information 32 is used in verifying the assumption described in the assumption narrowing sheet 311. The assumption verification information 32 is provided with the assumption verification sheet 321 corresponding to each assumption set in the assumption verification information 32. Therefore, the assumption verification sheet 321 is provided for all “assumptions” set in the assumption 311d of the assumption verification sheet 321 included in the assumption verification information 32. The assumption verification sheet 321 is a sheet in which practical procedure for verifying an assumption is described.

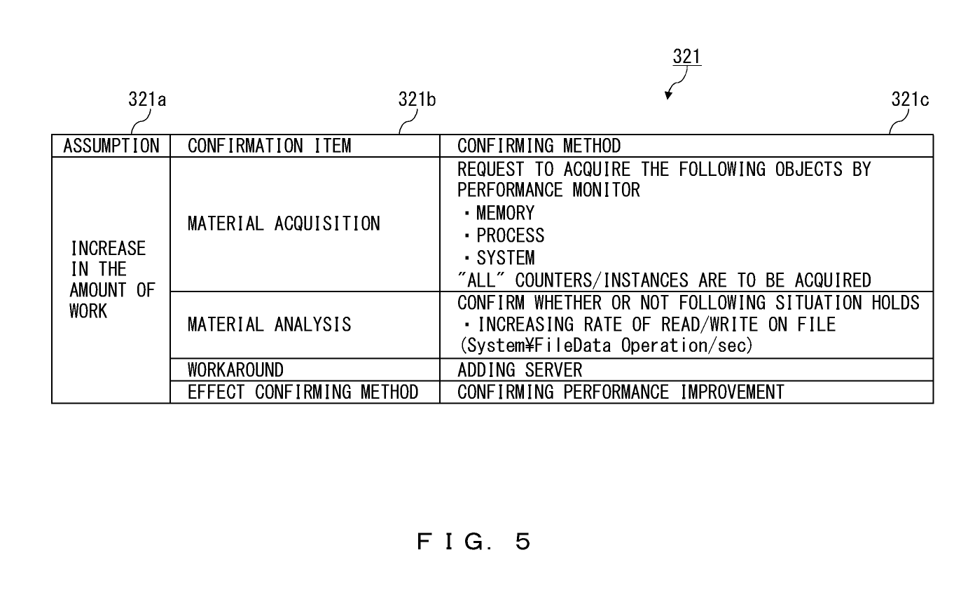

FIG. 5 is an example of the assumption verification sheet 321.

The assumption verification sheet 321 illustrated in FIG. 5 corresponds to the assumption of “increase in the amount of work” set in the assumption 311d of the assumption narrowing sheet 311. The assumption verification sheet 321 is configured by three items, that is, an assumption 321a, a confirmation item (C.I.) 321b, and a confirmation method 321c.

The assumption 321a is the same as the assumption set in the assumption 311d of the assumption narrowing sheet 311. Therefore, the assumption narrowing sheet 311 and the assumption verification sheet 321 are linked by the assumption 311d and the assumption 321a. The confirmation item 321b of the assumption verification sheet 321 includes four items, that is, “material acquisition (M. ACQ.)”, “material analysis (M. ANALY.)”, “workaround”, and “effect confirming method (E.C.M)”. A material acquisition is an item in which “material necessary to verify an assumption, its acquiring method, etc.” is described (set). A material analysis is an item in which the analyzing method and the verifying method for a collected material described in the material acquisition” is described. A workaround method is an item in which the workaround method for an assumption” is described. A effect confirming method is an item in which the method of confirming the effect when the method described in the workaround method is used is described.

Thus, the assumption verification sheet 321 has the descriptions of the material necessary for verifying the assumption set in the assumption 321a and its method of being acquired, the method of analyzing the material to be collected, the workaround method for verifying an assumption, and a method of confirming the effect when the workaround method is used.

In the assumption narrowing sheet 311 illustrated in FIG. 5, the assumption 321a describes “increase in the amount of work”. The confirmation items 321b corresponding to the “increase in the amount of work” can be four items, that is, “material acquisition”, “material analysis”, “workaround”, and “effect confirming method”. For each of the confirmation item 321b, the confirmation method 321c is described (set). In the example in FIG. 5, the described content of the confirmation method 321c corresponding to the confirmation item 321b of “material acquisition” is “request to acquire the following objects by a performance monitor.

Memory

Process

System

All counters/instances are to be acquired”.

The described content of the confirmation item 321b of “material analysis” is The rate (System¥FileData Operation/sec) of a read and a write for a file becomes higher”.

The performance monitor refers to the software for evaluate and record the performance and operation of a computer system. An object corresponds to a CI.

The described content of the confirmation method 321c for the confirmation item 321b of “workaround” is “adding a server”. The described content of the confirmation method 321c for the confirmation item 321b of “effect confirming method” is “confirming performance improvement”.

As known by the example above, the assumption verification sheet 321 including the settings of an assumption set in the assumption 311d of the assumption narrowing sheet 311, the material (acquired material) necessary to be acquired for verification of the assumption and the information about the method for acquiring the material etc., the method of analyzing the acquired material, the workaround for verification of the correctness of the assumption, and the effect confirming method when the workaround is performed.

### [Configuration of the CMDB 40]

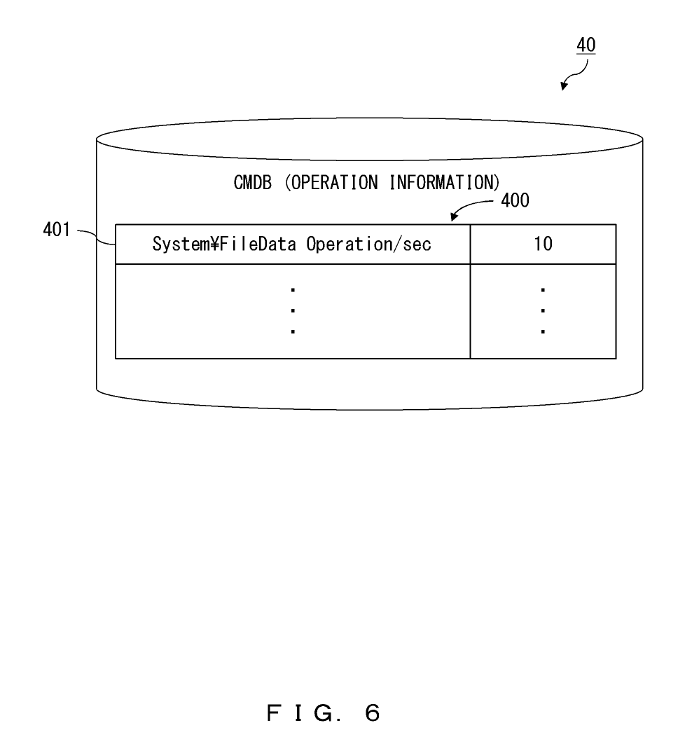

FIG. 6 is an example of storing operation information (information about a CI operating in an IT system) stored in the CMDB 40 in FIG. 1.

The CMDB 40 stores, for example, operation information 401 in each entry of a table 400 as illustrated in FIG. 6. In the example illustrated in FIG. 6, the first line of the table 400 stores operation information 401 formed by a set of a configuration item of “System¥FileData Operation/sec” and its value (10 sec). In FIG. 6, only the operation information 401 stored in the first line is illustrated, but the operation information 401 is stored in and after the second line.

### [Outline of the Operation of the Assumption Verification Information 32]

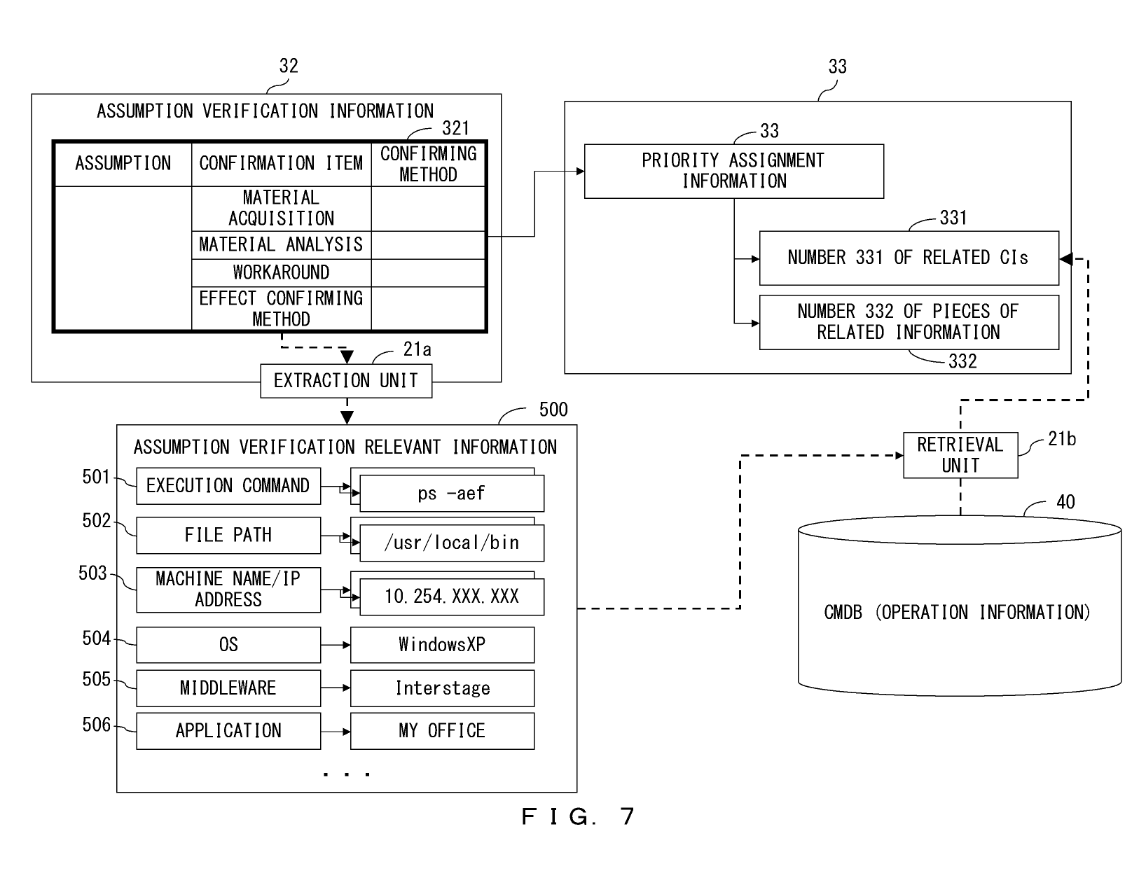

FIG. 7 illustrates the relationship between the assumption verification information 32 and the priority assignment information 33, and the outline of the operation of the operating CI extraction function unit 21.

As illustrated in FIG. 7, each assumption verification sheet 321 of the assumption verification information 32 is associated with a piece of priority assignment information 33.

The priority assignment information 33 is the information used in assigning priorities on the assumption narrowing sheet 311. The priority assignment information 33 has two types of number information, that is, a number 331 of related CIs and a number 332 of pieces of related information.

The number 331 of related CIs refers to the number of materials storing in the CMDB 40 the “operation information” in the materials (objects) described (set) in the “confirming method (C.M.)” corresponding to the “material acquisition” of the assumption verification sheet 321. The materials correspond to the CIs in the ITIL. Therefore, the number of materials storing the operation information in the CMDB 40 is equal to the number of CIs operating in the IT system.

The number 332 of pieces of related information is the number of “analysis items” indicating a difference between the operation information before a fault and the operation information after the fault larger than a predetermined threshold. The “analysis item” is an item described (set) in the “confirming method” corresponding to the “material analysis” of the assumption verification sheet 321. In the assumption verification sheet 321 illustrated in FIG. 5, “System¥FileData Operation/sec” described in the “confirming method” corresponding to the “material analysis” corresponds to an analysis item. The analysis item is CIs, which corresponds to the number of CIs whose the differences are larger than the predetermined threshold in the CIs having a performance value that fluctuates with time in the ITIL as an attribute value. Therefore, a difference in operation information about an analysis item is equal to a different in the performance value of the CI that fluctuates with time.

In the example illustrated in FIG. 7, the extraction unit 21a of the operating CI extraction function unit 21 extracts assumption verification sheet 321 relevant information (first assumption verification relevant information) 500 illustrated in FIG. 7. The assumption verification relevant information 500 includes the items of an execution command 501, a file path 502, a machine name/IP address 503, an OS 504, middleware 505, an application 506, etc. These items have a value of one or more attributes (attribute value). For example, the execution command 501 has “ps-aef” etc. as its attribute value. In addition, the file path 502 includes “/usr/local/bin” etc. as its attribute value.

The retrieval unit 21b of the operating CI extraction function unit 21 checks whether or not the CI corresponding to each item included in the assumption verification relevant information 500 is currently stored in the CMDB 40 as operation information. Then, the number of CIs stored as operation information in the CMDB 40 is counted, and the count result is set as the number 331 of related CIs in the assumption verification information 32.

### [Operation of the Operating CI Extraction Function Unit 21]

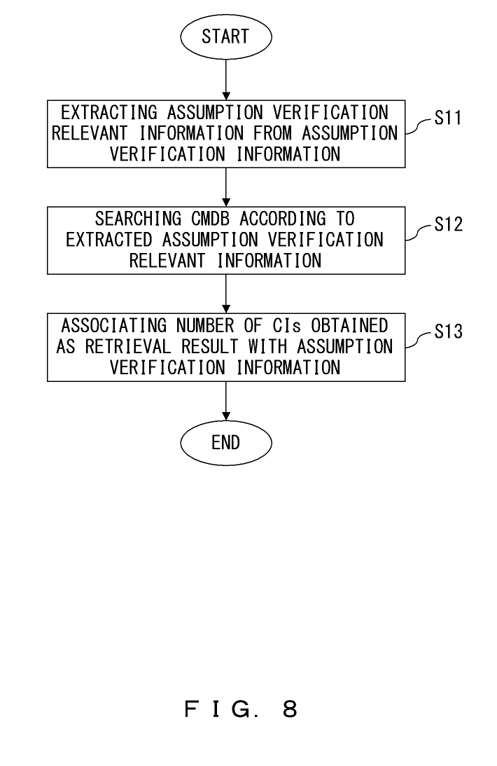

FIG. 8 is a flowchart of the procedure performed by the operating CI extraction function unit 21 extracting the number 331 of related CIs.

The operating CI extraction function unit 21 extracts the assumption verification relevant information 500 from the assumption verification information 32 (step S11). As described above, the operating CI extraction function unit 21 extracts by the extraction unit 21a the assumption verification relevant information 500 about each of the assumption verification sheet 321 included in the assumption verification information 32. In this case, the contents of the “confirming method” corresponding to the “material acquisition” of the assumption verification sheet 321 are referred to. The extracting process is described later in detail.

Next, the operating CI extraction function unit 21 searches the CMDB 40 according to the extracted assumption verification relevant information 500 (step S12). As described above, the operating CI extraction function unit 21 searches the CMDB 40 by the retrieval unit 21b, and retrieves and extracts the CI stored as operation information in the CMDB 40 in the CIs corresponding to the items included in the assumption verification relevant information 500.

Then, the operating CI extraction function unit 21 associates the number of the CIs obtained as a result of the retrieval with the assumption verification information 32 as the number 331 of related CIs (step S13), then terminating the process of the flowchart.

### [Outline of the Operation of the Operation Information Difference Extraction Function Unit 22]

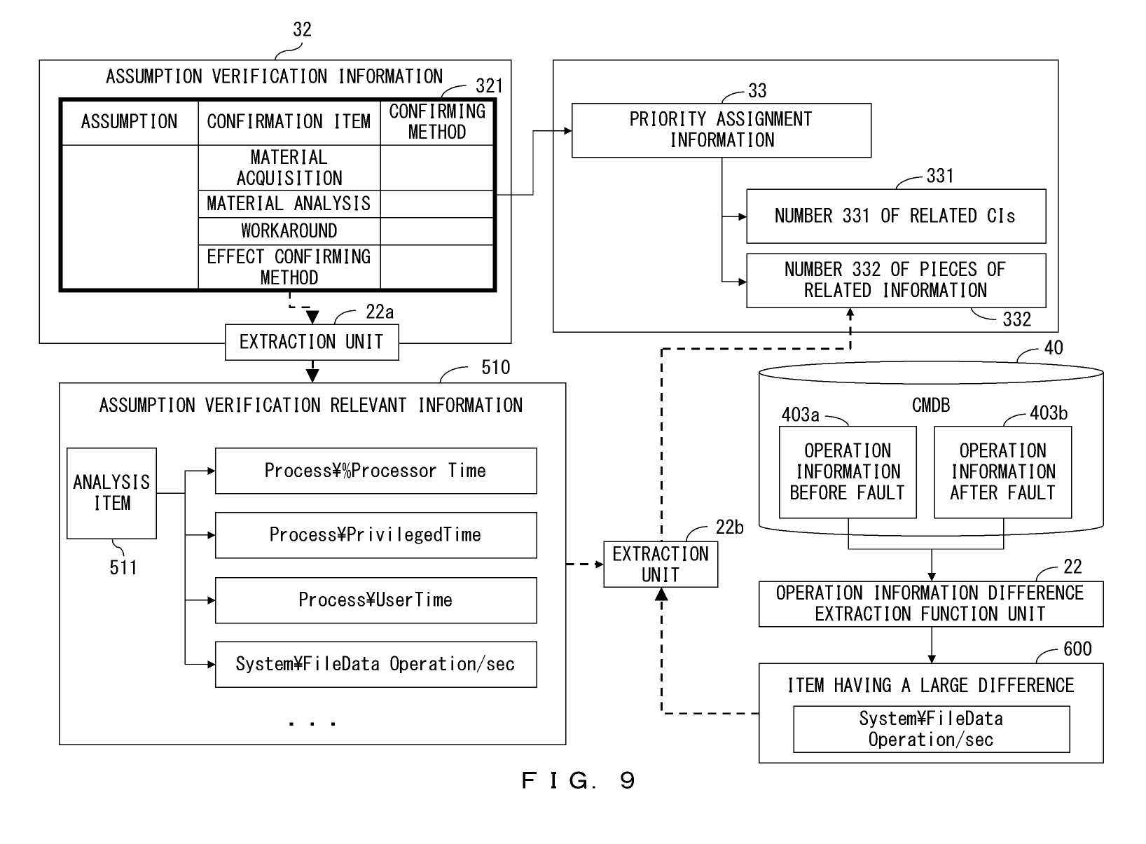

FIG. 9 is an explanatory view of the outline of the operation of the operation information difference extraction function unit 22. In FIG. 9, the components also illustrated in FIG. 7 are assigned the same reference numerals.

An extraction unit (first extraction unit) 22a and an extraction unit (second extraction unit) 22b illustrated in FIG. 9 are the functions included in the operation information difference extraction function unit 22.

The extraction unit 22a refers to the described content of the “confirming method” corresponding to the “material analysis” of the assumption verification sheet 321, and extracts assumption verification relevant information (second assumption verification relevant information) 510 including one or more analysis items. The assumption verification relevant information 510 includes as analysis items 511 such items as “Process¥Processor Time”, “process¥PrivilegedTime”, “Process¥UserTime”, “System¥FileData Operation/sec”, etc. in the example illustrated in FIG. 9.

As illustrated as a schematic diagram in FIG. 9, the CMDB 40 stores operation information 403a before a fault and operation information 403b after a fault for each analysis item 511. The operation information difference extraction function unit 22 checks the operation information 403a before a fault and the operation information 403b after a fault for all analysis items 511 stored in the CMBD 40, and extracts an item 600 having a large difference between an amount of information (for example, a value) before a fault and an amount of information after a fault. The extraction unit 22b refers to the assumption verification relevant information 510 and the item 600 having a large difference, and extracts an item included in the item 600 having a large difference in the analysis items 511 included in the assumption verification relevant information 510. The number of the extracted items is set as the number 332 of pieces of related information in the assumption verification information 32

### [Operation of the Operation Information Difference Extraction Function Unit 22]

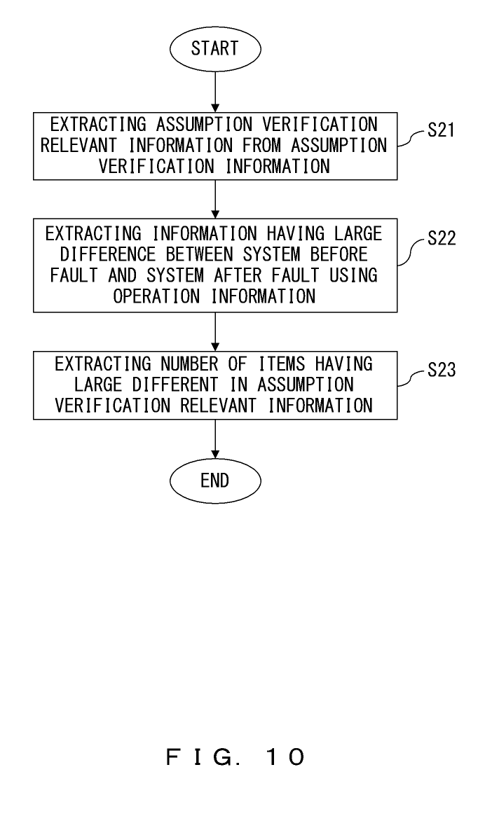

FIG. 10 is a flowchart of the procedure of the operation information difference extraction function unit 22.

The operation information difference extraction function unit 22 refers to the assumption verification information 32, and extracts the assumption verification relevant information 510 (step S21). The assumption verification relevant information 510 checks all assumption verification sheets 321 included in the assumption verification information 32 as described above, and extracts the assumption verification relevant information 510 from the contents described (set) in the “confirming method” corresponding to the “material analysis” of each of the sheets.

Thus, the assumption verification relevant information 510 is extracted for each assumption verification sheet 321 included in the assumption verification information 32.

Next, the operation information difference extraction function unit 22 refers to the assumption verification relevant information 510 of the assumption verification sheet 321 and the CMDB 40, and extracts an item having a large difference between the information before and after a fault (item 600 having a large difference) from each of the analysis items 511 included in the assumption verification relevant information 510 (step S22).

Then, the operation information difference extraction function unit 22 refers to the assumption verification relevant information 510 about the assumption verification sheet 321, and extracts an item matching the analysis item 511 included in the assumption verification relevant information 510 in the items included in the extracted item 600 having a large difference. The operation information difference extraction function unit 22 sets the number of extracted items as the number 332 of pieces of related information in the assumption verification information 32 (step S23). Then, the process of the flowchart terminates.

As described above, the number 332 of pieces of related information is set for each assumption verification sheet 321 of the assumption verification information 32.

### [Operations of the Extraction Unit 21a and the Extraction Unit 22a]

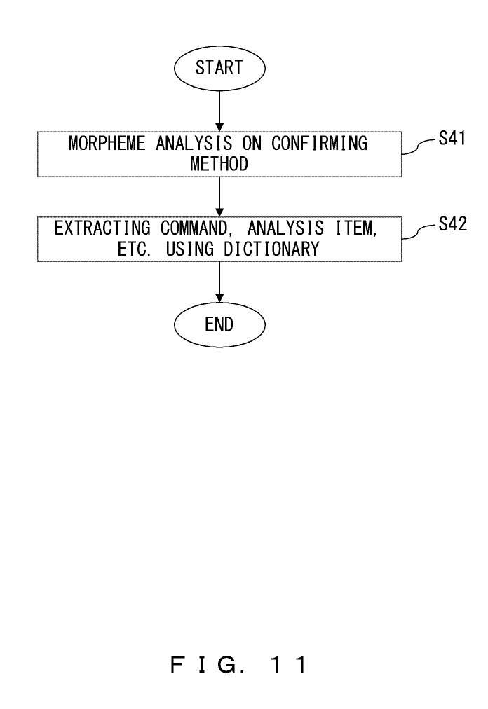

FIG. 11 is a flowchart of the procedure performed by the extraction unit 21a in FIG. 8 and the extraction unit 22a in FIG. 10. FIG. 11 corresponds to the details of the processes in step S11 in FIG. 8 and in step 21 in FIG. 10. The processes of the extraction unit 21a and the extraction unit 22a are different only in morpheme analysis object and extraction item, but the same with each other in algorithm. Therefore, in the description of the flowchart in FIG. 11, the extraction unit 21a and the extraction unit 22a are referred to as extraction units.

The extraction unit first performs a morpheme analysis on the confirmation method 321c corresponding to the confirmation item 321b of the assumption verification sheet 321 (step S41). In this process, the extraction unit 21a also performs the morpheme analysis on the “confirming method” corresponding to the “material acquisition”. The extraction unit 22a also performs the morpheme analysis on the “confirming method” corresponding to the “material analysis”. The morpheme analysis in step S41 is performed using, for example, the morpheme analysis technique used in a well-known natural language process. In this process, it is assumed that the content of the “confirming method” to be processed in the morpheme analysis in step S41 is described in a natural language.

The extraction unit then refers to a dictionary storing the knowledge about a morpheme etc., extracts an execution command, an analysis item, etc. from the description of the confirming method, and generates assumption verification relevant information (500, 510) (step S42). Then, the process of the flowchart is terminated. In step S42, the extraction unit 21a generates the assumption verification relevant information 500 including one or more items, and the extraction unit 22a generates the assumption verification relevant information 510 including one or more analysis items.

### [Use of the Priority Assignment Information 33]

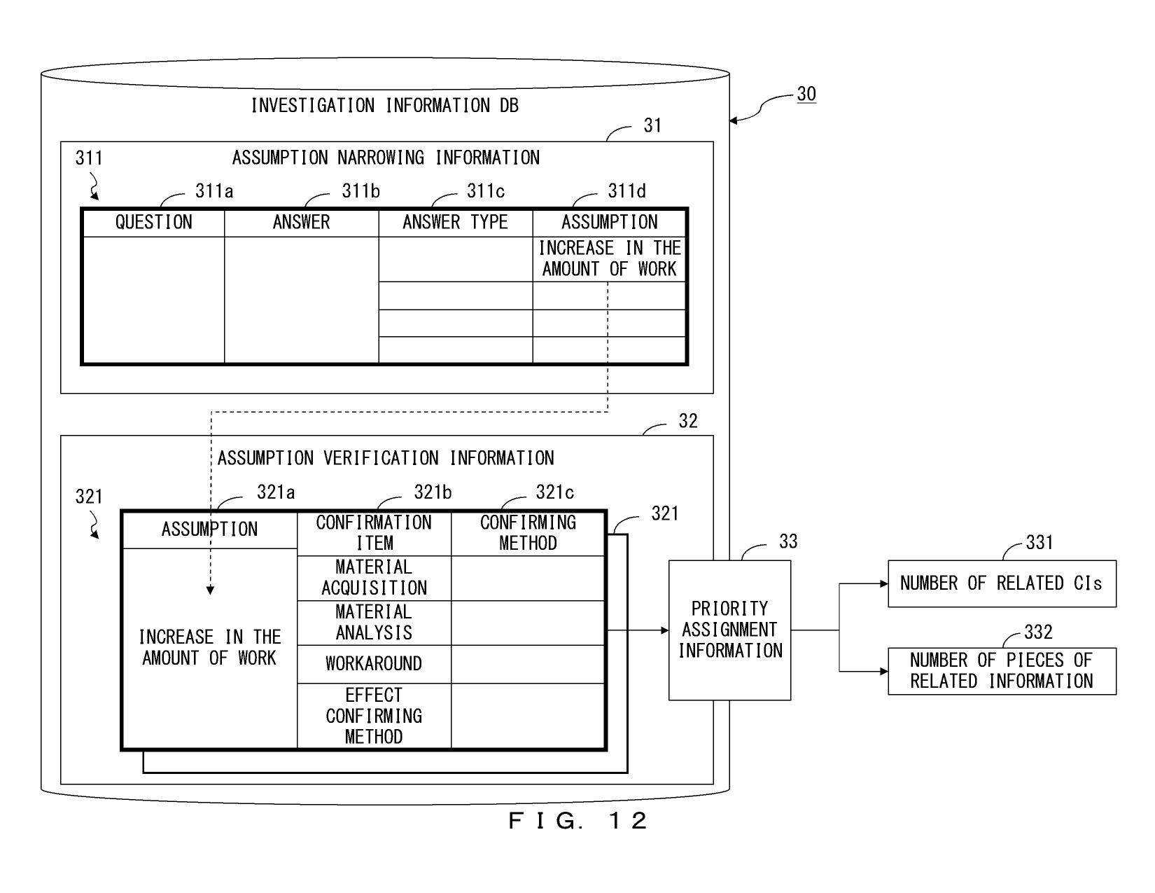

FIG. 12 illustrates the method of using the priority assignment information 33 associated with the assumption narrowing sheet 311 illustrated in FIG. 5.

The assumption 321a of the assumption verification sheet 321 illustrated in FIG. 12 has the description (setting) of an assumption of “increase in the amount of work”. The assumption verification sheet 321 is linked to the assumption narrowing sheet 311 whose assumption 311d has the description of an assumption similar to the above-mentioned assumption.

The assumption verification sheet 321 is associated with the priority assignment information 33.

The value of the priority assignment information 33 is a sum of the value of the number 331 of related CIs and the value of the number 332 of pieces of related information in the priority assignment information 33. When the assumption described in the assumption 311d of the assumption narrowing sheet 311 is only the “increase in the amount of work”, the value (priority) of the priority assignment information about the assumption narrowing sheet 311 is set to the value of the priority assignment information 33 associated with the assumption narrowing sheet 311. If the assumption other than the “increase in the amount of work” is also described in the assumption 311d of the assumption narrowing sheet 311, then the priority of the assumption narrowing sheet 311 is calculated by also considering the value of the priority assignment information 33 associated with the assumption verification sheet 321 (second assumption verification sheet 321) described in the assumption 321a including the assumption. In this case, the priority of the assumption narrowing sheet 311 is a sum of the value of the priority assignment information 33 about the assumption verification sheet 321 (first assumption verification sheet 321) having the assumption of “increase in the amount of work” and the value of the priority assignment information 33 about the second assumption verification sheet 321.

### [Use of the Priority Assignment Information 33]

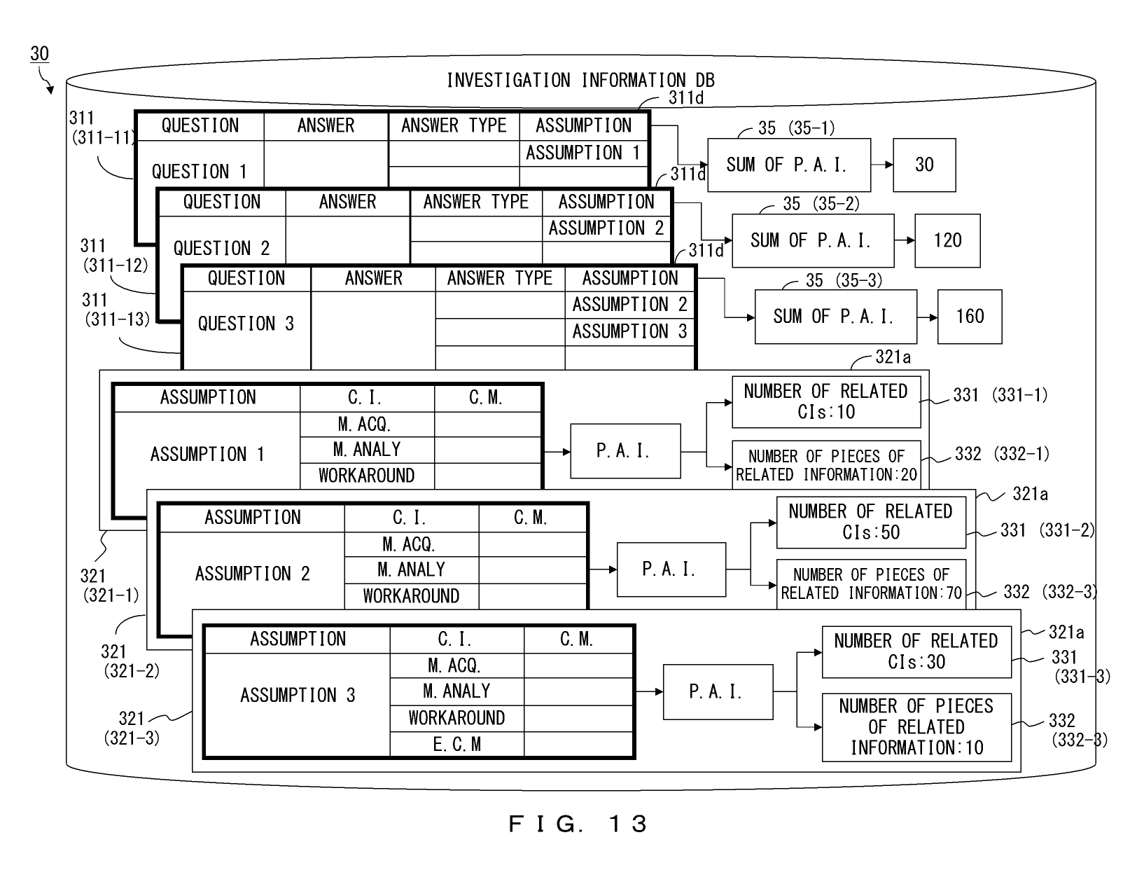

FIG. 13 is an explanatory view of the method of using the priority assignment information 33 associated with each assumption verification sheet 321.

The investigation information DB 30 illustrated in FIG. 13 stores three assumption narrowing sheets 311 (311-1, 311-2, and 311-3). The assumption 311d of the assumption narrowing sheet 311-1 has the description (setting) of an “assumption 1”, the assumption 311d of the assumption narrowing sheet 311-2 has the description (setting) of an “assumption 2”, and the assumption 311d of the assumption narrowing sheet 311-3 has the descriptions of “assumption 2” and “assumption 3”. Therefore, the assumption narrowing information 31 including the assumption narrowing sheets 311-1 through 311-3 includes three assumptions of the assumptions 1, 2, and 3. The investigation information DB 30 stores the three assumption verification sheets 321 (321-1, 321-2, and 321-3) corresponding to the respective assumptions. The assumption verification sheet 321-1 is a verification sheet for the assumption 1, the assumption verification sheet 321-2 is a verification sheet of the assumption 2, and the assumption verification sheet 321-3 is a verification sheet of the assumption 3.

In the example illustrated in FIG. 13, the value of the number 331 of related CIs of the priority assignment information 33 (33-1) associated with the assumption verification sheet 321-1 is “10”, and the value of the number 332 of pieces of related information is “20”. As described above, since the value of the priority assignment information 33 is a sum of the value of the number 331 of related CIs and the value of the number 332 of pieces of related information, the value of the priority assignment information 33-1 is “30”. Similarly, the value of the priority assignment information 33 (33-2) associated with the assumption verification sheet 321-2 is “120” (the value of the number 331-2 of related CIs is “50”, the value of the number 332-2 of pieces of related information is “70)”, and the value of the priority assignment information 33 (33-3) associated with the assumption verification sheet 321-3 is “40” (the value of the number 331-3 of related CIs is “30”, and the value of the number 332-2 of pieces of related information is “10”).

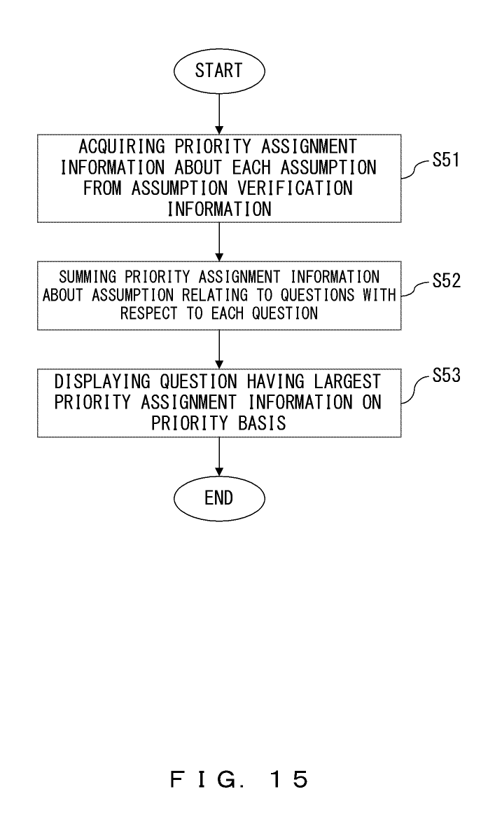

In the present embodiment, a sum (sum 35 of priority assignment information) of the values of the priority assignment information 33 associated with the assumption verification sheets 321 corresponding to all assumptions described in the assumption 311d of each assumption narrowing sheet 311 is obtained. The sum is used as the priority of the assumption narrowing sheet 311. Therefore, as illustrated in FIG. 15, the sum 35 (35-1) of priority assignment information about the assumption narrowing sheet 311-1 is “30”, and the sum 35 (35-2) of priority assignment information about the assumption narrowing sheet 311-2 is “160” (=120+40). Therefore, in this case, higher priorities are assigned to the assumption narrowing sheet 311-3, the assumption narrowing sheet 311-2, and the assumption narrowing sheet 311-1 in this order.

In the present embodiment, the sum 35 of priority assignment information about each assumption narrowing sheet 311 calculated in the above-mentioned method is used in assigning priorities to the assumption narrowing sheets 311. Practically, the larger the sum 35 of priority assignment information is, the higher priority the assumption narrowing sheet 311 is assigned.

The isolation support information display function unit 10 calculates the sum 35 of priority assignment information by the above-mentioned method for all assumption narrowing sheets 311 stored in the investigation information DB 30. Then, the “question” and the “answer” described in the question 311a and the answer 311b of the assumption narrowing sheet 311 having a high priority are displayed on the screen of the terminal such as a system console on the priority basis. Therefore, the “question” and the “answer” described on the assumption narrowing sheet 311 having a high priority are displayed on a priority basis on the screen of the terminal of a user (system administrator etc.).

### [Display of “Question” and “Answer” Using the Sum 35 of Priority Assignment Information]

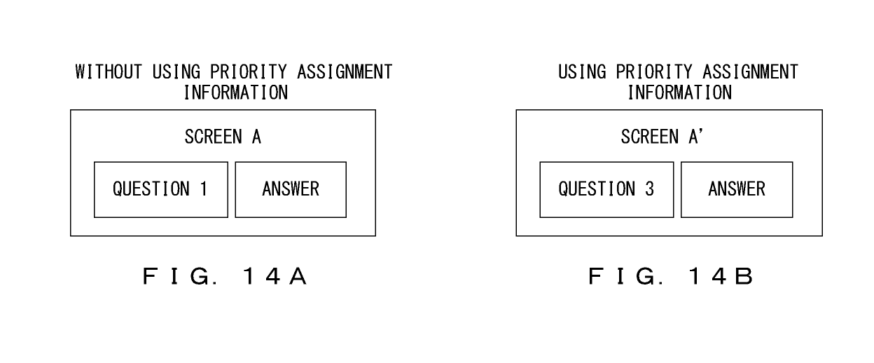

FIG. 14 is a schematic diagram of the method of displaying a “question” and “answer” using the sum 35 of priority assignment information according to the present embodiment.

When the sum 35 of priority assignment information is not used, the assumption narrowing sheet 311 is read in the order stored in the investigation information DB 30. Therefore, in the example illustrated in FIG. 13, the “question” (question 1) and “answer” first displayed on the terminal screen of a user correspond to the contents described in the assumption narrowing sheet 311-1 as illustrated in FIG. 14A.

On the other hand, in the present embodiment, the isolation support information display function unit 10 displays the “question” and the “answer” described in the assumption narrowing sheet 311 having the highest priority on the terminal screen of the user on a highest priority basis. Therefore, according to the present embodiment, the “question” and the “answer” first displayed on the terminal screen of the user correspond to the contents described in the assumption narrowing sheet 311-3 as illustrated in FIG. 14B. On the screen A′ illustrated in FIG. 14B, the display contents of “question 3” are the same as the described contents of the question 311a of the assumption verification sheet 321-3, for example. The display contents of the “answer” are the described contents of the answer 311b and the described contents of the answer type 311c of the assumption verification sheet 321-3. In this case, for example, the described contents of the answer 311b are displayed as the title of the “input box of answer”. Then, the contents of all items of the answer type 311c are displayed as the selection input data for the input box of the answer through the pull-down menu.

According to the present embodiment, a question is issued to a user on the terminal screen of the user in an interactive mode. In this case, the order of the questions to a use is in accordance with the sum 35 of priority assignment information about the assumption narrowing sheet 311. That is, questions to a user are issued in the order in which the question described in the assumption narrowing sheet 311 having a larger sum 35 of priority assignment information is issued earlier.

### [Operation of the Isolation Support Information Display Function Unit 10]

FIG. 15 is a flowchart of the procedure performed by the isolation support information display function unit 10.

The isolation support information display function unit 10 first refers to the assumption verification information 32 stored in the investigation information DB 30, and acquires the priority assignment information 33 associated with all assumption verification sheets 321 included in the assumption verification information 32 (step S51).

The isolation support information display function unit 10 then calculates the sum 35 of priority assignment information about all assumption verification sheets 321 included in the assumption narrowing information 31 stored in the investigation information DB 30 by the method illustrated in FIG. 14 (step S52).

The isolation support information display function unit 10 then checks the sum 35 of priority assignment information of each assumption narrowing sheet 311, and displays the “question” and the “answer” described in the assumption narrowing sheet 311 having the largest value of the sum 35 of priority assignment information on a priority basis on the screen of the terminal (step S53). Then, the process of the flowchart is terminated.

In addition, although not illustrated in the flowchart, the isolation support information display function unit 10 displays the “question” and the “answer” described in the assumption narrowing sheet 311 having the largest value of the sum 35 of priority assignment information as described above. Then, in response to an instruction from the user of the terminal, the “question” and the “answer” described in the assumption narrowing sheet 311 are sequentially displayed on the screen of the terminal in the descending order from the largest value of the sum 35 of priority assignment information. Thus, the user of the terminal can sequentially answer the questions from the “question” having the highest priority in the interactive mode with the system according to the present embodiment.

### [Hardware Configuration of the Computer for Achieving the Present Embodiment by Executing a Program]

The performance trouble isolation support apparatuses 1 and 2 of the present embodiment can be realized by a computer using a program. It means that a computer executes software (performance trouble isolation support program according to the present embodiment), thereby allowing the computer to function as the performance trouble isolation support apparatus 1. In this case, the performance trouble isolation support program according to the present embodiment is realized as software for directing a computer to perform the functions of the isolation support information display function unit 10 and the item optimization function unit 20 provided for the performance trouble isolation support apparatuses 1 and 2.

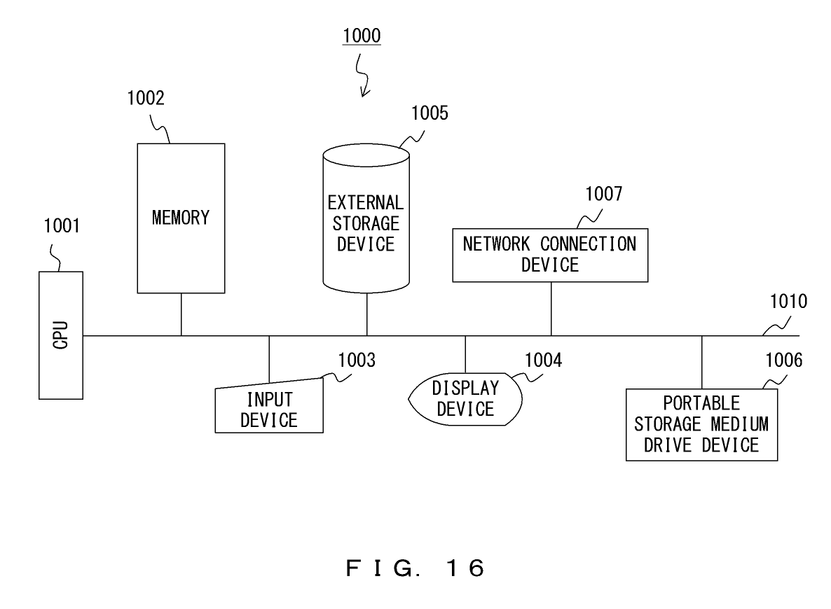

FIG. 16 is a block diagram of the hardware configuration of a computer achieving the function of the isolation support information display function unit 10 and the item optimization function unit 20 of the performance trouble isolation support apparatuses 1 and 2 of the present embodiment by executing the performance trouble isolation support program of the present embodiment.

A computer 1000, illustrated in FIG. 16, includes a CPU 1001, memory 1002, an input device 1003, a display device 1004, an external storage device 1005, a portable storage medium drive device 1006, a network connection device 1007, etc. The CPU 1001 is connected to other components 1002 through 1007 of the computer 1000 via a bus 1010.

The CPU 1001 is a central processing unit for controlling the entire operation of the system of the computer 1000. The memory 1002 is a main storage device having an area into which the software executed by the CPU 1001 such as a BIOS (basic input/output system), an OS (operating system), the performance trouble isolation support program, etc. is loaded, an area storing intermediate data generated during the execution of the program, etc. The memory 1002 is configured by ROM (read only memory), RAM (random access memory), etc. The input device 1003 is provided with a pointing device such as a keyboard, a mouse, etc. The display device 1004 is a CRT display, a liquid crystal display, etc. The external storage device 1005 reads and writes data on a built-in storage medium by a magnetic system, a magneto optical system, etc. The external storage device 1005 can be, for example, an HDD (hard disk drive) etc. The portable storage medium drive device 1006 reads and write data on a portable storage medium attachable to and detachable from the body. The portable storage medium drive device 1006 may be, for example, a CD (compact disc), a DVD (digital video disc), a USB (universal serial bus) memory, etc. The network connection device 1007 may be a network card etc. for connection to a LAN (local area network) etc. configured in a data center, an in-house system, etc. The LAN is connected to a WAN (wide area network) such as the Internet, a VPN (virtual private network), etc. through network equipment such as a router etc.

The performance trouble isolation support program according to the present embodiment is recorded on a portable storage medium (not illustrated in the attached drawings) attachable to and detachable from the portable storage medium drive device 1006, and is distributed through the portable storage medium, for example. In addition, it may be downloaded over a network such as the Internet etc., and may be installed on a portable storage medium (not illustrated in the attached drawings) attached to the external storage device 1005 or the portable storage medium drive device 1006.

The performance trouble isolation support program installed on the external storage device 1005 etc. is activated by operating the input device 1003, such as a mouse, on the user interface screen such as a GUI (graphical user interface) displayed on the display device 1004. In addition, the investigation information DB 30 and the CMDB 40 according to the present embodiment are prepared in, for example, the external storage device 1005. The operation of preparing the investigation information DB 30 is performed by a system administrator by, for example, performing an inputting operation from the input device 1003 on the GUI screen.

The functions of the isolation support information display function unit 10 and the item optimization function unit 20 of the configuration information management apparatus according to the present embodiment may also be provided for a user by executing the performance trouble isolation support program according to the present embodiment at a server held by an ASP (application service provider). The functions of the isolation support information display function unit 10 and the item optimization function unit 20 of the present embodiment may also be provided for a user over a network such as the Internet etc. by a Saas (software as a service).

According to the present embodiment, the number of materials (CIs) (number 331 of related CIs) described as acquired material in each of the assumption verification sheets 321 included in the assumption verification information 32 using the CMDB 40 and the diagnostic tool 60 is counted. Also using the CMDB 40 and the diagnostic tool 60, the number of analysis items 511 (CIs) (number 332 of pieces of related information) having large differences of the operation information between the CI before a fault and the CI after a fault included in each of the assumption verification sheets 321 included in the assumption verification information 32 is counted. On the basis of the count result, the sum (sum 35 of priority assignment information) of the number 331 of related CIs and the number 332 of pieces of related information about all assumptions described (set) in each assumption narrowing sheet 311 included in the assumption narrowing information 31 is calculated, and the larger the sum 35 of priority assignment information is, the higher the priority set to the assumption narrowing sheet 311. Then a question described (set) in the assumption narrowing sheet 311 having a high priority is issued to a user such as a system administrator on a priority basis. Thus, questions are issued to the user sequentially from an important question having a higher possibility of a cause of performance trouble (fault) of an IT system. As a result, it is possible to quickly isolate the cause of the performance trouble (fault) of the IT system, thereby achieving fast recovery of the fault of the IT system.

According to the present embodiment, a sum of the number 331 of related CIs and the number 332 of pieces of related information is used in assigning a priority of the assumption narrowing sheet 311, but one of the numbers may be used. Also according to the present embodiment, the isolation support information display function unit 10 displays the contents of an inquiry item on the terminal screen of the user. However, the presentation of an inquiry item to a user may be performed using other reporting devices such as voice etc.

As described above, the performance trouble isolation support apparatus according to the present embodiment assigns priorities to inquiry items to be issued to a user to isolate the cause of performance trouble when the performance trouble occurs in an information system according to the operation information about the components of the information system. Therefore, the priority of the inquiry item can be optimized.

As described above, the performance trouble isolation support apparatus according to the present embodiment can present on, for example, a screen display a user with an inquiry item assigned a priority by the performance trouble isolation support program in a descending order from the highest priority. Therefore, a cause of performance trouble can be quickly isolated.

According to the present embodiment, the performance trouble isolation support apparatus optimizes the priorities of inquiry items for narrowing an assumption of a cause of performance trouble of an information system depending on the current situation of the information system. Therefore, the cause of the performance trouble of the information system can be quickly isolated, and the performance trouble can be quickly restored to a normal state.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A recording medium which stores a performance trouble isolation support program used to direct a computer to function as a performance trouble isolation support apparatus for isolating a cause of performance trouble by issuing an inquiry in an interactive mode to a user when the performance trouble occurs in an information system, the performance trouble isolation support program comprising the processes of:
acquiring operation information about a component of the information system; and
optimizing an inquiry item by referring to assumption narrowing information stored in a storage unit and including a plurality of inquiry items for an inquiry to a user to narrow causes of a fault of the information system to a specific assumption, assumption verification information including information necessary to verify assumptions for each of a plurality of assumptions included in the assumption narrowing information, and the operation information, generating priority assignment information necessary to assign priorities to the inquiry items, and assigning priorities to the inquiry items included in the assumption narrowing information according to the priority assignment information.

2. The recording medium according to claim 1, wherein:
the assumption narrowing information comprises an assumption narrowing sheet in which an item provided for each question for narrowing an assumption depending on contents of a question is described;
the assumption verification information comprises an assumption verification sheet in which an item provided for each assumption included in the assumption narrowing information and related to a practical procedure for verifying an assumption is described.

3. The recording medium according to claim 2, wherein
the item described in the assumption narrowing sheet comprises a question content, an answer to the question content, a type of the answer, and an assumption of a cause of a fault corresponding to the type of the answer.

4. The recording medium according to claim 2, wherein
the item described in the assumption verification sheet comprises at least an assumption content, the component required to verify the assumption and a method of acquiring the component, and a method of analyzing the component acquired in the method of acquiring.

5. The recording medium according to claim 1, wherein
the priority assignment information comprises a number of components included in the assumption verification information and being operated in an information system.

6. The recording medium according to claim 1, wherein
the priority assignment information comprises a number of items included in the assumption verification information and required in analyzing assumption verification having a large difference in operation information between the information system before a fault and the information system after the fault.

7. The recording medium according to claim 1, wherein
the priority assignment information is a sum of a number of components included in the assumption verification information and currently being operated in the information system, and a number of items necessary in analyzing assumption verification included in the assumption verification information and having a large difference in operation information between the information system before a fault and the information system after the fault.

8. The recording medium according to claim 1, wherein
the acquiring operation information uses a CMDB (configuration management database).

9. The recording medium according to claim 1, wherein
the acquiring operation information uses a diagnostic tool for grasping an operation state of an information system from a network.

10. The recording medium according to claim 1, wherein
the program further comprises
presenting a user with a question in a descending order from an inquiry item having a higher priority on a basis of a priority assigned by the inquiry item optimization unit.

11. A performance trouble isolation support apparatus which isolates a cause of performance trouble by issuing an inquiry in an interactive mode to a user when the performance trouble occurs in an information system, comprising:
an operation information acquisition unit acquiring operation information about a component of the information system;
a storage unit storing assumption narrowing information including a plurality of inquiry items for an inquiry to a user to narrow causes of a fault of the information system to a specific assumption, and assumption verification information including information necessary to verify assumptions for each of a plurality of assumptions included in the assumption narrowing information; and
an inquiry item optimization unit referring to the assumption verification information stored in the storage unit and operation information held by the operation information acquisition unit, generating priority assignment information necessary to assign priorities to the inquiry items, and assigning priorities to the inquiry items included in the assumption narrowing information according to the priority assignment information.

12. The apparatus according to claim 11, wherein:
the assumption narrowing information comprises an assumption narrowing sheet in which an item provided for each question for narrowing an assumption depending on contents of a question is described;
the assumption verification information comprises an assumption verification sheet in which an item provided for each assumption included in the assumption narrowing information and related to a practical procedure for verifying an assumption is described.

13. The apparatus according to claim 11, wherein
the priority assignment information comprises a number of components included in the assumption verification information and being operated in an information system.

14. The apparatus according to claim 11, wherein
the priority assignment information comprises a number of items included in the assumption verification information and required in analyzing assumption verification having a large difference in operation information between the information system before a fault and the information system after the fault.

15. The apparatus according to claim 11, further comprising
a question presentation unit presenting a user with a question in a descending order from an inquiry item having a higher priority on a basis of an inquiry item assigned a priority by the inquiry item optimization unit.
